(19) United States
(12) Patent Application Publication
(10) Pub. No.: US 2023/0134175 A1
(43) Pub. Date: May 4, 2023

(54) FLAT APERTURE TELEPHOTO LENS

(71) Applicant: Soliddd Corp., New York, NY (US)

(72) Inventor: Richard A. Muller, Berkeley, CA (US)

(21) Appl. No.: 17/976,444

(22) Filed: Oct. 28, 2022

Related U.S. Application Data
(60) Provisional application No. 63/275,051, filed on Nov. 3, 2021.

(51) Int. Cl. G02B 13/02; H04N 5/225

(52) U.S. Cl. CPC G02B 13/02; H04N 5/2257

(57) ABSTRACT

One embodiment provides an imaging device, including: a sparsely-filled optical aperture having a shape forming an outer portion of the optical aperture, wherein at least a portion of an inner portion formed by the outer portion of the optical aperture is not a part of the optical aperture; and imaging optics, wherein the imaging optics include at least one reflection device optically located after the optical aperture and at least one imaging sensor optically located after the at least one reflection device, wherein light entering the optical aperture reflects from the at least one reflection device onto the at least one imaging sensor. Other embodiments are described herein.

### CROSS REFERENCE TO RELATED APPLICATIONS

This application claims priority to U.S. Provisional Pat. Application Serial No. 63/275,051, filed on Nov. 3, 2021, the content of which are incorporated by reference herein.

### FIELD OF THE INVENTION

The present invention relates generally to image capture systems, more particularly, to image capture device systems that utilize a flat sparsely-filled aperture to provide a telephoto lens in a thin form factor and also provide zoom capabilities for the flat sparsely-filled aperture imaging device.

### BACKGROUND OF THE INVENTION

Many people utilize portable, handheld information handling devices (e.g., smart phones, tablets, smart watches, etc.) to capture images. For many people it is much easier to capture an image with a device that serves many purposes, instead of utilizing a dedicated imaging device. Additionally, dedicated imaging devices may be large and heavy and a person may not want to carry it everywhere in the event that the perfect photo opportunity arises. Thus, the portable, handheld information handling device solves some of these problems. Since these devices are utilized so frequently for image capturing, the imaging mechanisms, imaging optics, and on-board image processing have become more advanced to provide for better quality images as compared to older portable, handheld information handling devices. However, due to the form factor of the information handling device, these devices and imaging mechanisms suffer from some deficiencies as compared to larger, dedicated imaging devices. For example, some features that are found on dedicated imaging devices are not available on the described information handling devices due to the size of the information handling device.

For example, information handling devices do not have a true telephoto lens. The challenge is the diffraction limit. The diffraction limit of the human eye is set by the pupil diameter, which is typically 5 mm in daylight. For visible light, with a wavelength of 0.55 micrometers, that sets the Rayleigh limit at about 30 seconds of arc (0.5 minute of arc). A 7× set of binoculars can give no more detail unless it delivers a resolution of 30 sec/7 ≈ 4 sec of arc. To do that its diffraction limit, typically set by the front lens, must be at least 7× the diameter of the human pupil, that is, about 35 mm. When binoculars are designated 7×35, that means they magnify 7× compared to normal eyesight, and have a 35 mm aperture, thus allowing them to deliver adequate optical resolution at that magnification.

A telephoto lens is characterized by its long focal length. For standard 35 mm cameras, a 50 mm focal length gives the standard photographic image. A 100 mm focal length gives 2× magnification and a 350 mm lens delivers 7× magnification, the same as 7×35 binoculars. The necessary focal length for a telephoto lens causes a challenge in putting the telephoto lens on an information handling device, particularly one having a thin form factor. One technique for increasing the focal length within a thin form factor is by folding the optics, an example of which is shown in FIG. 2. In this example, the light enters through a 6 mm aperture, is reflected, and focused on an imaging array that is 1.5 cm distant from the aperture. Thus, the folded lens design allows a focal length of 1.5 cm in a mobile phone that may have only 6 or 7 mm of thickness to carry the image. As is evident from the diagram, the width of the aperture is not significantly greater than that of the human eye, so the resolution is limited to about 30 arc sec. But if a larger-diameter aperture is used, then the light from that aperture will not fit in the thin mobile camera.

### SUMMARY OF THE INVENTION

In order to create a telephoto lens that will fit in a thin information handling device form factor, the described system provides an imaging device including a sparsely-filled optical aperture and imaging optics. The sparsely-filled optical aperture is in a shape that forms an outer portion of the optical aperture. In other words, and as an example, the optical aperture may be a ring shape, where the inner portion of the ring is not part of the optical aperture. This is in contrast to traditional telephoto lenses in which the entire area of the aperture is filled. For example, FIGS. 3A - 3D illustrates examples of information handling devices having sparsely-filled optical apertures. In these examples, the white portion corresponds to the optical aperture(s) and the gray portion corresponds to other parts of the information handing device. As illustrated in these examples, the optical aperture is in a ring shape that has an inner portion that corresponds to the information handling device and not the optical aperture(s).

Due to the thin form factor of the information handling device, the imaging optics may be in the folded optics design, for example, as found in FIG. 2. Thus, the imaging device also includes imaging optics that include at least one reflection device that is optically located after the optical aperture and at least one imaging sensor optically located after the at least one reflection device. When light enters the optical aperture, the light reflects from the at least one reflection device onto the at least one imaging sensor.

Thus, the system, device, and method described herein provide a novel technique for providing a telephoto lens within a thin form factor information handling device. Specifically, the described system and method utilizes a sparsely-filled aperture that provides a long focal length and a large-diameter aperture that can be included within a thin design, even if the sparsely-filled aperture is included in an information handling device that can support a thicker imaging device. Additionally, the described system and method provides a technique that allows for a zoom feature with the described telephoto lens utilizing one or more movable lenses.

In summary, one aspect provides an imaging device, including: a sparsely-filled optical aperture having a shape forming an outer portion of the optical aperture, wherein at least a portion of an inner portion formed by the outer portion of the optical aperture is not a part of the optical aperture; and imaging optics, wherein the imaging optics include at least one reflection device optically located after the optical aperture and at least one imaging sensor optically located after the at least one reflection device, wherein light entering the optical aperture reflects from the at least one reflection device onto the at least one imaging sensor.

Another aspect provides information handling device, including: an imaging device, including: an sparsely-filled optical aperture having a shape forming an outer portion of the optical aperture, wherein at least a portion of an inner portion formed by the outer portion of the optical aperture is not a part of the optical aperture; and imaging optics, wherein the imaging optics include at least one reflection device optically located after the optical aperture and at least one imaging sensor optically located after the at least one reflection device, wherein light entering the optical aperture reflects from the at least one reflection device onto the at least one imaging sensor; at least one memory device; and at least one processor operatively coupled to the imaging device and the at least one memory device.

Another aspect provides a method, including: receiving light through an sparsely-filled optical aperture, wherein the optical aperture is formed in a shape forming an outer portion of the optical aperture, wherein at least a portion of an inner portion formed by the outer portion of the optical aperture is not a part of the optical aperture; and reflecting the light using at least one reflection device optically located after the optical aperture onto at least one imaging sensor optically located after the at least one reflection device.

### A BRIEF DESCRIPTION OF THE DRAWINGS

FIG. 1 illustrates a block diagram showing an example apparatus device.

FIG. 2 illustrates an example folded optics design.

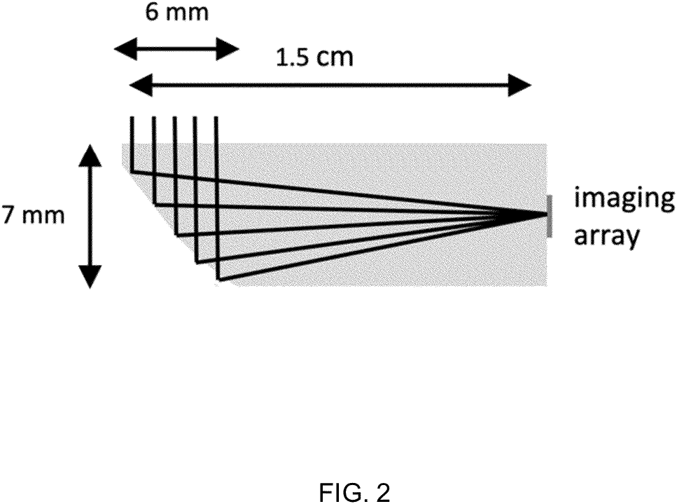

FIGS. 3A - 3D illustrates example information handling devices with one or more sparsely-filled aperture.

FIG. 4 illustrates an example cross-section of the optics design illustrated in FIG. 3B.

FIG. 5 illustrates an example resolution of the human eye and of the 7× ring optics of FIG. 3B and FIG. 4.

FIG. 6 illustrates an example cross-section of the optics design of a multiple camera embodiment.

FIG. 7 illustrates an example cross-section of the optics design of a double flat camera with two focal lengths.

FIGS. 8A - 8B illustrates two other example cross-sections of sparsely-filled aperture layouts.

FIGS. 9A - 9F illustrates example non-ring sparsely-filled apertures.

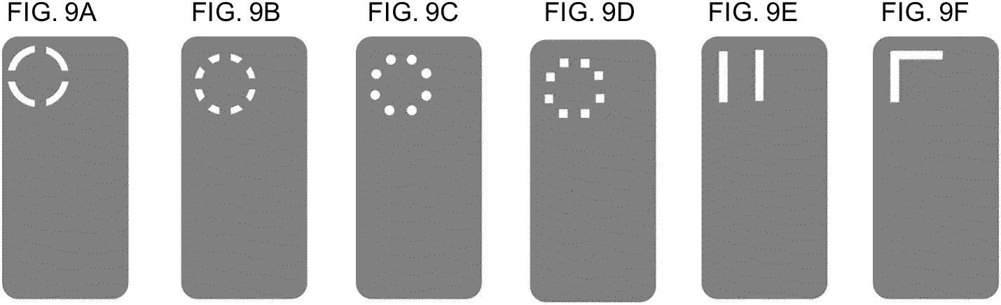

FIG. 10 illustrates an example cross-section of the optics design of a sparsely-filled aperture with a zoom feature.

FIG. 11 illustrates an example cross-section of the optics design of a sparsely-filled aperture with a zoom feature and having a flatter design.

FIG. 12 illustrates an example plan view of the optics design illustrated in FIG. 10.

FIG. 13 illustrates an example design for a zoom feature of an imaging device having a stationary imaging sensor.

FIG. 14 illustrates the zoom ratio as a function of the position of the first movable lens illustrated in FIG. 13.

### DETAILED DESCRIPTION OF THE INVENTION

In accordance with the present application, the described system and method provide a technique for addressing the challenges of a long focal length and large-diameter aperture within a thin form factor or a thin imaging device. Specifically, the described system and method utilize an aperture that is not-completely-filled, also referred to as a sparsely-filled aperture. Such a sparsely-filled aperture allows for an imaging device that can be thin, for example, less than 10 millimeters in thickness.

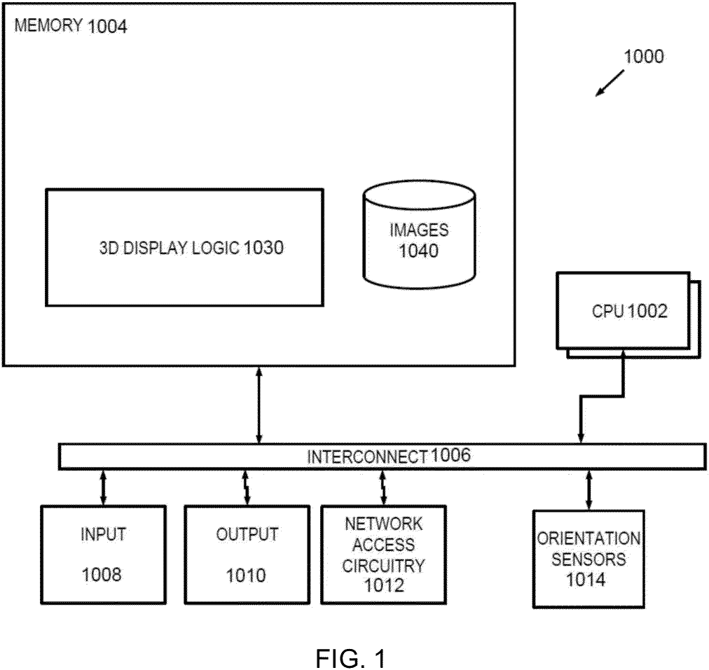

Referring to FIG. 1, a device 1000, for example, that includes the described imaging device or that can be used within the imaging device, is described. The device 1000 includes one or more microprocessors 1002 (collectively referred to as CPU 1002) that retrieve data and/or instructions from memory 1004 and execute retrieved instructions in a conventional manner. Memory 1004 can include any tangible computer readable media, e.g., persistent memory such as magnetic and/or optical disks, ROM, and PROM and volatile memory such as RAM.

CPU 1002 and memory 1004 are connected to one another through a conventional interconnect 1006, which is a bus in this illustrative embodiment and which connects CPU 1002 and memory 1004 to one or more input devices 1008 and/or output devices 1010, network access circuitry 1012, and orientation sensors 1014. Input devices 1008 can include, for example, a keyboard, a keypad, a touch-sensitive screen, a mouse, and a microphone. Output devices 1010 can include one or more displays - such as an OLED (organic light-emitting diode), a microLED, or liquid crystal display (LCD), or a printed image of sufficiently high resolution - and one or more loudspeakers for associated audio. Network access circuitry 1012 sends and receives data through computer networks. Orientation sensors 1014 measure orientation of the device 1000 in three dimensions and report measured orientation through interconnect 1006 to CPU 1002. These orientation sensors may include, for example, an accelerometer, gyroscope, and the like, and may be used in identifying the position of the user.

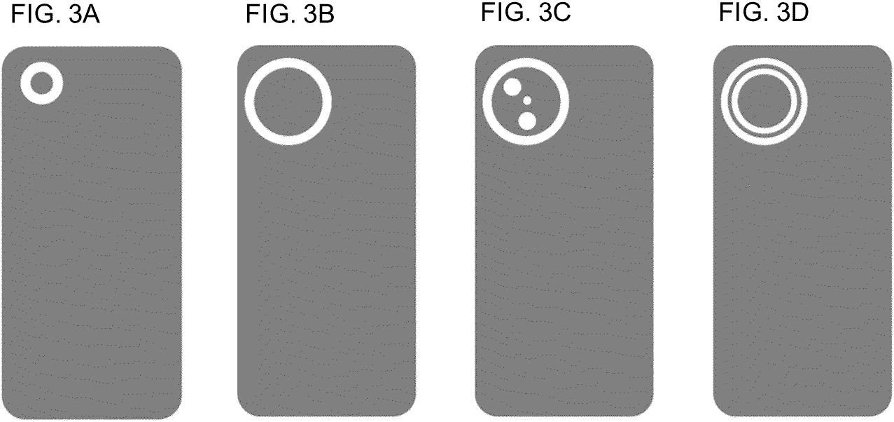

One type of sparsely-filled aperture is referred to as a “ring aperture.” The ring aperture is an optical aperture having a circular shape that forms an outer portion of the optical aperture. At least a part of the area enclosed by the outer portion of the optical aperture is not a part of the optical aperture. In other words, the optical aperture forms a circular shape that has an inner portion that is not a part of the optical aperture. An example of a ring aperture is shown in FIG. 3A, placed on the back of a commercially available mobile phone. This will be the example used here throughout. However, this is not intended to be a limiting example, as the described imaging device can be used on any information handling device.

In FIG. 3, the aperture is represented by the white region on the back of the phone. The ring lens in FIG. 3A gives 3× the resolution of the human eye, and thereby qualifies as a true telephoto lens. If we take a 35 mm equivalent, and say that for such a camera, 35 mm serves as the standard eye resolution, then this camera gives the equivalent of 3×35mm = 105 mm equivalent focal length. FIG. 3B shows a larger ring telephoto that gives 7× eye resolution, and thus is equivalent to 7× binoculars, or to a camera equivalent of 225 mm. Thus, the size of the sparsely-filled optical aperture influences a maximum magnification value of the imaging device.

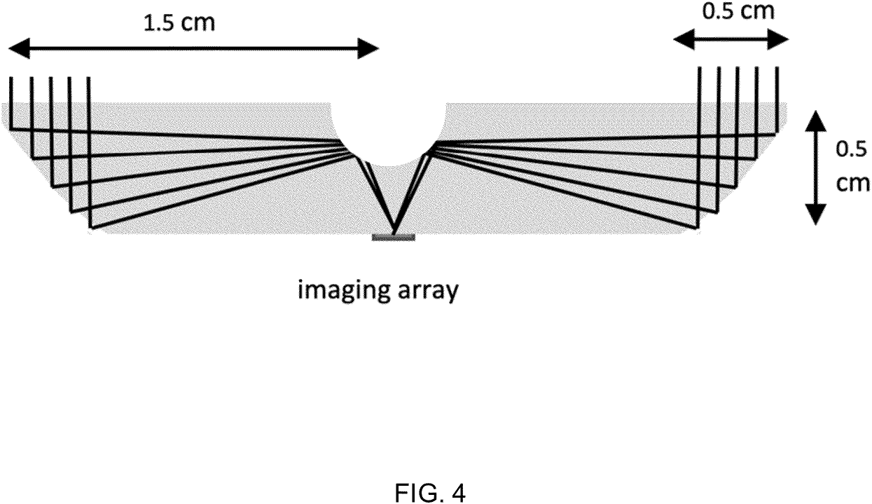

A cross-section of the FIG. 3B optics is shown in FIG. 4. The dark black lines indicate ray paths through the imaging optics. The imaging optics include at least one reflection device optically located after the optical aperture and at least one imaging sensor optically located after the at least one reflection device. Light entering the optical aperture reflects from the at least one reflection device onto the at least one imaging sensor. As can be seen in FIG. 4, the light entering the ring optics (illustrated entering at the top of the cross-section) is focused toward the center of the ring onto the imaging array, also referred to as an imaging sensor. In the implementation shown, the focus is achieved by two reflectors, the ring reflector that folds the light towards a central spherical or semi-spherical reflector that folds the light towards the imaging array. In another embodiment, rather than reflectors, lenses may be utilized. However, the reflectors tend to minimize chromatic aberration. It should be noted that the diffraction limit of a sparsely-filled aperture is superior to that of a filled aperture due to the fact that the average spacing of points on the sparsely-filled aperture is greater than it is for a filled aperture.

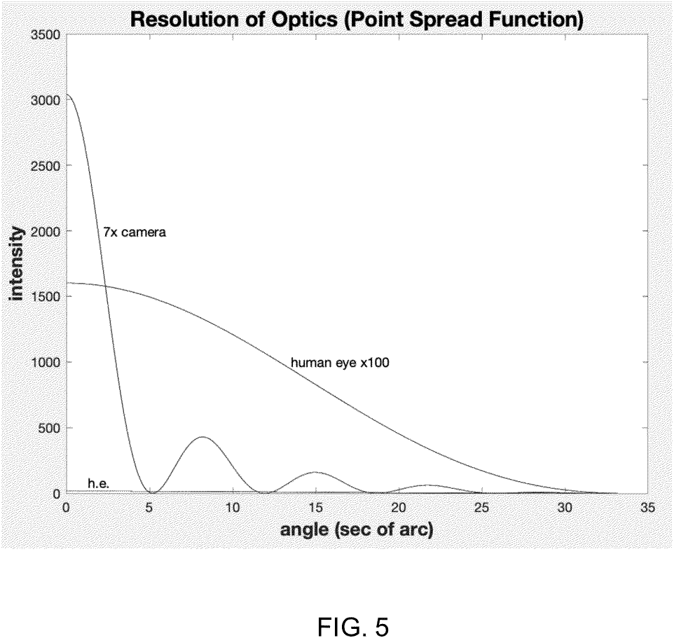

The diffraction pattern of the 7× lens (FIG. 3B) for a point source of light (e.g. a star) is shown in FIG. 5, along with the diffraction pattern for a camera that has a 5 mm filled circular aperture which is comparable to the geometry of the human eye. In FIG. 5, the image of a star-like object (point-spread-function) is shown for the human eye and for the 7× camera (FIG. 3B). Also plotted is the human eye image with its intensity multiplied by a factor of 100, so its shape can be more easily compared to that of the ring aperture. As seen, the 7× camera of FIG. 3B yields a brighter image. This is due to the fact that the larger lens captures more light, and that it squeezes the light into a smaller diffraction peak.

Images in digital cameras can be “sharpened” by applying image processing. One of the best kinds of such processing is the application of a Wiener filter to the image. In many cases, a Wiener filter is the optimum method for improving the quality of an arbitrary image. Applying such filters typically consists of doing a fast-Fourier transform (FFT) to the image, dividing the result by the Wiener filter function, which is typically a function based on the Fourier transform of the aperture combined with an estimate of the image signal-to-noise ratio. Such filtering is well-known to those practiced in the art of image manipulation, and it typically improves the resolution of the image by a factor of 2 to 3.

This same type of sharpening can be accomplished with the ring aperture optics without applying an image processing or applying a Wiener filter to the image. It is expected the ring aperture will give a factor of 2-3 improved resolution. Note that we do not include this factor of 2-3 in our statement that the ring optics can improve over a filled circular aperture by a factor of 7× or more. If we included it, we would say that the ring aperture could improve over an unfiltered filled circular aperture by a factor of 14× to 21×. However, since such filtering is available to a filled circular aperture camera, to make a comparison to the filled aperture we do not include it.

The ring aperture has a series of secondary peaks, seen in FIG. 5 near 8 arcsec, 15 arcsec, and 22 arcsec. These can create rings around point-like objects, such as stars. To reduce such artifacts, the described system can include image processing in the camera. This will happen if a Wiener filter based on the point-spread-function of the ring aperture is applied to the image. Other more advanced filter methods can also be used, such as those based on artificial intelligence. Artificial intelligence can improve an image better than a Wiener filter by deducing the nature or context of the image (a face? a building? a tree?) and by applying different filters to different parts of the image. As an alternative, the filtering could be applied by software once the image has been moved to an external computer.

The properties of non-filled apertures are not widely known to optical designers, since in most camera and telescope designs, it is considered important to bring as much light as possible from the region of the aperture to the focus. The described system and method demonstrate that if the goal is not maximum light, but high resolution in an extremely compact space, then a sparsely-filled aperture can provide that. The value of a non-filled aperture is further enhanced when strong computing power is available, as is true when the camera is implemented in a modern mobile phone.

In the example of FIG. 3 reflected optics were used; this assists in minimizing chromatic aberration. However, this may result in a small amount of diffractive aberration, since blue light focuses slightly more sharply than does red light. Such an aberration could be corrected in software, or by the introduction of corrective optics in the camera. Utilizing only a slice of a full reflecting sphere, as shown in the illustrated figures, may result in minimal spherical aberrations. Accordingly, instead of a sphere, the surface could be parabolic shape, or it could be a different shape that minimizes total aberration, including spherical and astigmatism. The central reflector, which is depicted as spherical in FIG. 4, could be other shapes, including parabolic, hyperbolic, or other shape than spherical. The shape could be configured to minimize aberrations. Moreover, a lens or combination of lenses could be placed between the sparsely-filled optics camera and the image sensor to minimize aberrations.

The discussed example was chosen to match the dimensions of common mobile phones. However, the method described here (non-filled aperture, digital filters applied in image processing) has application in situations in which a thin imaging device is desired.

Since most of the space within the ring is empty (referred to as the inner portion formed by the outer portion of the optical aperture), additional cameras could be combined with the sparsely-filled optical aperture imaging device. FIGS. 3C and 3D show a mobile phone with additional apertures. These apertures could be conventional cameras, for example, as shown in FIG. 3C as filled circular lenses within the inner portion or additional sparsely-filled optical aperture imaging device, as shown in FIG. 3D).

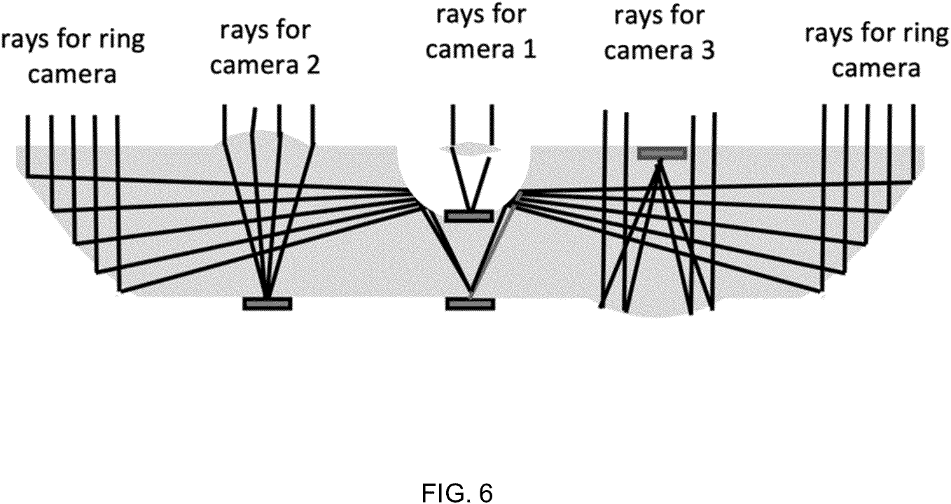

FIG. 6 shows a cross-section of a multiple camera embodiment that includes one large-diameter ring camera and three smaller-dimeter conventional cameras, for example, as illustrated by FIG. 3C. Two of the smaller-diameter conventional cameras are based on focus by lens and one is based on focus by reflection. Of course, lens and reflective focus could be combined.

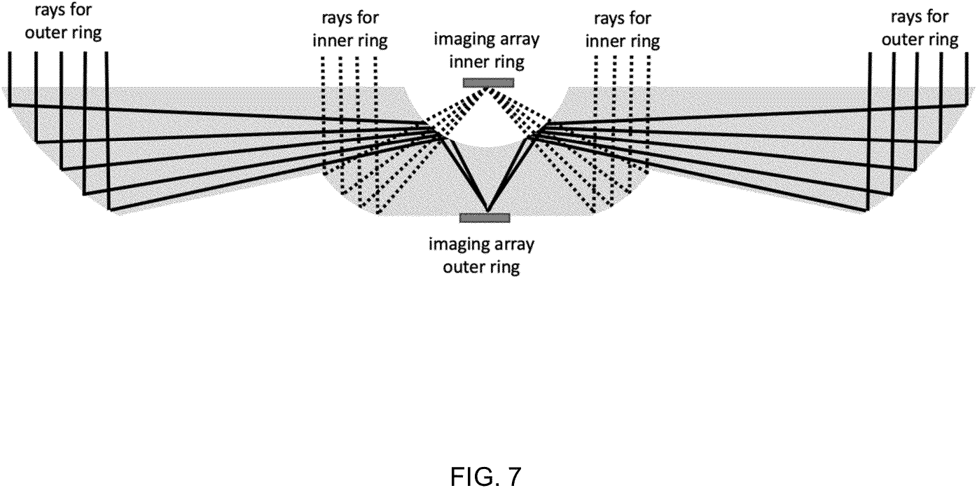

Thus, as shown in FIG. 3C and FIG. 6, it can be seen that the large ring optical aperture does not necessary prohibit the use of other cameras in the space within the ring. It is also possible to use two or more ring optical aperture imaging devices on the same part of the mobile phone or other flat device, for example, as illustrated in FIG. 3D. A cross-section of the optics of such an example is illustrated in FIG. 7.

The large but non-filled aperture can provide the angular resolution needed for a compact telephoto camera that can fit in a thin object such as a mobile phone. Additionally, image compensation can eliminate the image artifacts that otherwise could make the image less satisfactory. While the previously described example provides a particular geometry that achieves these objectives, other geometric layouts can achieve a similar high angular resolution. Two of these are shown in FIG. 7.

In FIG. 7, two ring cameras (“outer ring” and “inner ring”) create two separate images. For the outer ring, the ray path is similar to that shown in FIG. 4. The inner ring camera, in this implementation, takes advantage of the fact that most of the light that hits a glass surface near normal incidence will pass though the surface rather than be reflected. Thus, the light from the outer ring lens is reflected (by total internal reflection) off the inner spherical surface, but the light from the inner ring lens passes through. Other designs and geometric layouts are possible and contemplated. For example, the two cameras in FIG. 7 could have additional cameras added in the manner shown in FIG. 4.

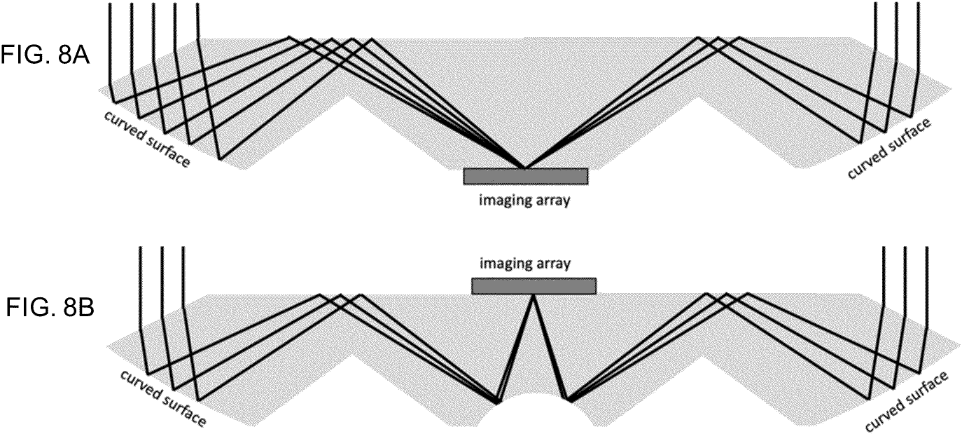

Once the value of a ring geometry is recognized, with additional value obtainable by image processing, then other layouts can be used that would be evident to a person practiced in the field of camera optics. FIG. 8A and FIG. 8B shows two such embodiments. These use both refractive optics and reflective optics. There are many combinations that can be used.

Note also that, in the designs depicted in this document, many of the surfaces do not participate in required reflections. These surfaces can be blackened, that is, made to absorb stray light, by using methods well-known to those practiced in the art of camera design.

While the description has described an optical aperture having a ring shape, other shapes can be used. To achieve high (e.g. about 7×) resolution in all directions, the aperture needs to contain regions that are substantially separated in all directions (all azimuths). This can be done with rings, but it can be done in other ways. Example embodiments illustrating the use of different partially-filled apertures are shown in FIGS. 8A - 8F

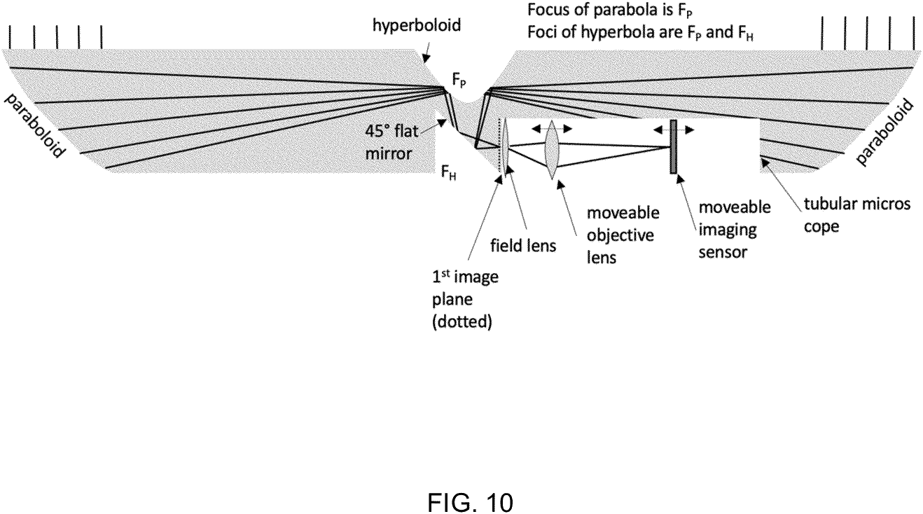

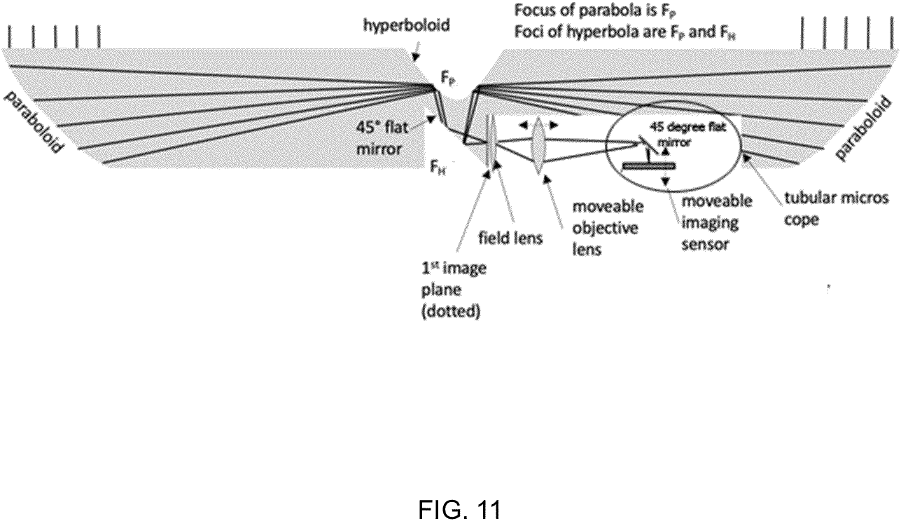

In addition to the telephoto function of the previously described optical aperture and imaging device, a zoom capability can be included with the described optical aperture. To include a zoom capability, additional components are added to the imaging optics of the previously described imaging optics. Specifically, instead of the light or image that is captured hitting the imaging sensor from the central reflection device, it is reflected by a mirror to make it have a vertical orientation. This mirror may be a 45° mirror. The image location could also contain an optional field lens, which is common in optics design. FIG. 10 illustrates an example cross-section of the optics for such an optical aperture having a zoom capability. Similar optics can be achieved using lenses instead of mirrors or a combination of mirrors and lens. Additionally, the interior of the optics may be plastic, glass, air, and/or the like. Another example cross-section of the optics for such an optical aperture having a zoom capability is illustrated in FIG. 11. In FIG. 11, an additional mirror has been added before the imaging sensor. This design allows for flatter imaging optics, thereby allowing for fitment in a thinner form factor.

The optional field lens is normally placed at or near the location of an image. It is designed to focus the objective lens (in this diagram, that is the ring paraboloid) onto or near the objective lens of the microscope. Since in the described system and method the imaging array is moving, the fixed focus of the field lens would be somewhere along the path of motion of that lens. That microscope has an objective lens that reimages the initial image onto a sensor array.

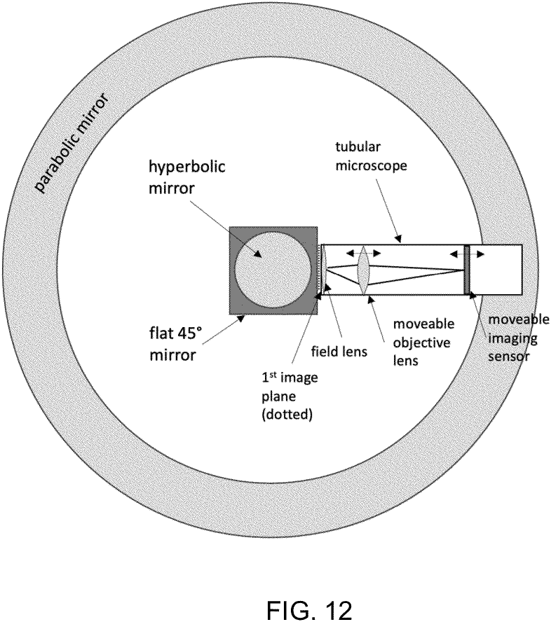

FIG. 10 and FIG. 11 shows that the microscope is in the path of some of the rays of light that are being imaged. However, the design is such that this blockage can be acceptable. This is clarified in FIG. 12, which shows a schematic plan view of the zoom telescope. The microscope only blocks a small wedge of the incoming light, and this can be designed to have minimal impact on the final image.

The first image, that of the parabola-hyperbola combination, is called the primary image. The image of the field lens and objective lens of the microscope is called the secondary image. By motion of the objective lens and the imaging array, also referred to as an imaging sensor, the desired zoom effect can be achieved. This is most readily seen by making the assumption that the objective lens is a thin lens, and then using the thin lens approximation. If the objective lens has a focal length of f, and it is placed a distance d1 from the primary image, then the secondary image will appear a distance d2 from the objective lens, where, according to the thin lens formula:

$$1 / \text{f = 1} / \text{d1 + 1} / \text{d2}$$

To get an image that is in-focus, once d1 is chosen, then d2 must be chosen to match this formula. This can be done by mechanical linkages, or by separate control of the positions of the objective lens and the positioning array.

In this equation, f is fixed, but d1 and d2 are adjustable. The magnification M is given by:

$$\text{M=} \text{d2} / \text{d1}$$

Using Eq 2 to eliminate d2 from Eq 1, and solving for M, we get

$$\text{M=} \text{f} / \left(\text{d1-f}\right)$$

Thus, by changing d1 and d2 according to Eq 1, we keep the image in focus, but achieve a variable magnification according to Eq 3. FIG. 12 is drawn such that d2 ≈ 2 d1, so the zoom magnification is ≈ 2. This can be changed by moving the lens and the imaging sensor.

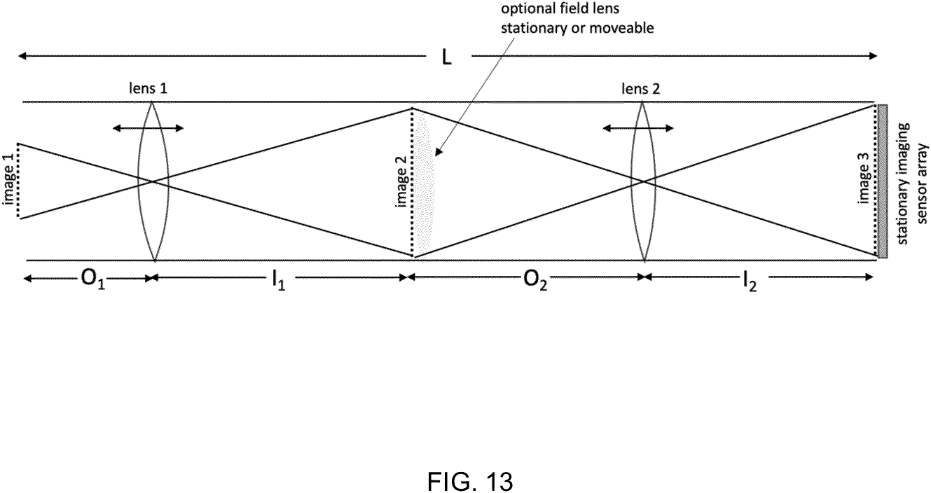

In some designs, it might be desirable to have the sensor at a fixed position. For this case, a zoom telescope can be achieved by having two moving lenses. However, the positioning of the two lenses involves a complicated formula that is not easily achieved by mechanical means alone. However, it is easily achieved if a simple microprocessor is used to position the two lenses. A design for the zoom microscope that has a fixed position detector in shown in FIG. 13.

In this Figure, the distance between the primary image (from the parabaloid-hyperbolide-45° mirror combination) is labeled “image 1”. (This is the same as “1st image plane” on FIG. 10 and FIG. 11.) However in the design of FIG. 13, there are two moveable lenses (lens 1 and lens 2) and an imaging sensor array that is fixed at a distance L from the location of FIG. 10 and FIG. 11. Lens 1 with focal length f1 is located a changeable distance O1 from the fixed image. The image is formed at distance I2 to the right of this lens. If f1 is the focal length of this lens, then:

$$1 / \text{f1 = 1} / \text{O1 + 1} / \text{I1}$$

Similarly for the second lens, with focal length f2:

$$1 / \text{f2 = 1} / \text{O2 + 1} / \text{I2}$$

We have the length constraint equation:

$$\text{O1 + I1 + O2 + I2 = L}$$

The magnification of the microscope is the ratio of the sizes of image 3 to that of image 1. The magnification of lens 1 is I1/O1; the magnification of lens 2 is I2/O2; the magnification of the combination is the product of these:

$$\text{M =} \text{I1 I2} / \left(\text{O1 O2}\right)$$

The diagram also shows a field lens. In the optimum configuration, this lens would be positioned at image 2 and have a focal length that images lens 1 onto lens 2. However, a field lens need not be precisely focused and in many aspects can be fixed in a region in the center of the range of motion of image 2. In FIG. 13, the optional field lens is shown in light grey. It is designed to approximately image the face of lens 1 onto the face of lens 2.

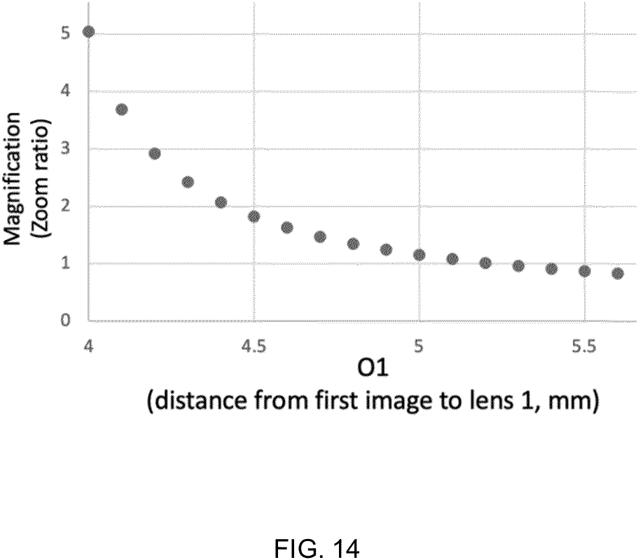

For a given value of O1, we can consider equations 4, 5, 6, and 7 to be four equations with four unknowns: I1, 02, I2, and M. Thus, we can solve for all of these using algebra. The magnification M that results from these equations is a function of O1 (the placement of the first lens), assuming that the second lens is correctly placed at the location O1 + I1 + O2 from image 1. For the chart illustrated in FIG. 14, L = 24 mm, f1 = 3 mm, f2 = 2.5 mm. Then, for a given O1, the value of M is calculated from the equations and plotted.

The chart of FIG. 14 shows that if lens 1 is placed 4 mm from image 1, then image 3 on the detector (as distance L from image 1) will be magnified by a factor of 5, that is, will have a 5× zoom. A zoom slightly less than 1 is obtained if O1 is greater than 5.3. This example is illustrative; other values can be obtained by this design by appropriate choice of L, f1, and f2.

Image stabilization can be achieved by lateral motion of the sensor array, using a separate tilt sensor to compute the required motion.

The above description is illustrative only and is not limiting. The present invention is defined solely by the claims which follow and their full range of equivalents. It is intended that the following appended claims be interpreted as including all such alterations, modifications, permutations, and substitute equivalents as fall within the true spirit and scope of the present invention.

What is claimed is:

1. An imaging device, comprising:
a sparsely-filled optical aperture having a shape forming an outer portion of the optical aperture, wherein at least a portion of an inner portion formed by the outer portion of the optical aperture is not a part of the optical aperture; and
imaging optics, wherein the imaging optics comprise at least one reflection device optically located after the optical aperture and at least one imaging sensor optically located after the at least one reflection device, wherein light entering the optical aperture reflects from the at least one reflection device onto the at least one imaging sensor.

2. The imaging device of claim 1, wherein the at least one reflection device comprises a central reflector and at least one outer reflector.

3. The imaging device of claim 2, wherein at least one of the central reflector and the at least one outer reflector is at least one of: spherical and paraboloid in shape.

4. The imaging device of claim 1, wherein the at least one reflection device comprises at least one lens.

5. The imaging device of claim 1, wherein the imaging device is less than 10 millimeters in thickness.

6. The imaging device of claim 1, wherein the shape comprises a circular shape.

7. The imaging device of claim 1, wherein the imaging optics further comprises at least two lenses, wherein at least one of the at least two lenses comprises a movable objective lens and wherein another of the at least two lenses comprises a field lens.

8. The imaging device of claim 7, wherein the at least one imaging sensor is a movable imaging sensor, and wherein movement of the movable objective lens and the movable imaging sensor provides a zoom feature for the imaging device.

9. The imaging device of claim 7, further comprising at least one second movable objective lens.

10. The imaging device of claim 9, wherein the at least one imaging sensor is a stationary imaging sensor and wherein movement of the movable objective lens and the at least one second movable objective lens provides a zoom feature for the imaging device.

11. The imaging device of claim 1, wherein a size of the sparsely-filled optical aperture influences a maximum magnification value of the imaging device.

12. An information handling device, comprising:
an imaging device, comprising:
a sparsely-filled optical aperture having a shape forming an outer portion of the optical aperture, wherein at least a portion of an inner portion formed by the outer portion of the optical aperture is not a part of the optical aperture; and
imaging optics, wherein the imaging optics comprise at least one reflection device optically located after the optical aperture and at least one imaging sensor optically located after the at least one reflection device, wherein light entering the optical aperture reflects from the at least one reflection device onto the at least one imaging sensor;
at least one memory device; and
at least one processor operatively coupled to the imaging device and the at least one memory device.

13. The information handling device of claim 12, further comprising a second imaging device, wherein the second imaging device comprises a second optical aperture having a shape forming an outer portion of the second optical aperture and located within the outer portion of the optical aperture and wherein the second optical aperture forms a second inner portion that is not part of the second optical aperture.

14. The information handling device of claim 12, wherein the at least one reflection device comprises at least one of a central spherical reflector, a central semispherical reflector, and at least one lens.

15. The information handling device of claim 12, wherein the imaging device is less than 10 millimeters in thickness.

16. The information handling device of claim 12, wherein the imaging optics further comprises at least two lenses, wherein at least one of the at least two lenses comprises a movable objective lens and wherein another of the at least two lenses comprises a field lens.

17. The information handling device of claim 16, wherein the at least one imaging sensor is a movable imaging sensor, and wherein movement of the movable objective lens and the movable imaging sensor provides a zoom feature for the information handling device.

18. The information handling device of claim 16, further comprising at least one second movable objective lens; and
wherein the at least one imaging sensor is a stationary imaging sensor; and
wherein movement of the movable objective lens and the at least one second movable objective lens provides a zoom feature for the imaging device.

19. The information handling device of claim 12, further comprises a second imaging device comprising a second optical aperture located within the inner portion formed by the outer portion of the optical aperture.

20. The information handling device of claim 12, wherein the information handling device is a handheld, portable information handling device.

21. A method, comprising:
receiving light through a sparsely-filled optical aperture, wherein the optical aperture is formed in a shape forming an outer portion of the optical aperture, wherein at least a portion of an inner portion formed by the outer portion of the optical aperture is not a part of the optical aperture; and
reflecting the light using at least one reflection device optically located after the optical aperture onto at least one imaging sensor optically located after the at least one reflection device.
